(19) United States
(12) Patent Application Publication
(10) Pub. No.: US 2018/0276669 A1
(43) Pub. Date: Sep. 27, 2018

(54) Fraud Remedy Tool

(71) Applicant: Bank of America Corporation, Charlotte, NC (US)

(72) Inventor: Brendan Patrick McIntyre, Wilmington, DE (US)

(21) Appl. No.: 15/464,472

(22) Filed: Mar. 21, 2017

(51) Int. Cl. G06Q 20/40; G06Q 20/36; G06Q 20/32

(52) U.S. Cl. CPC G06Q 20/4016; G06Q 20/322; G06Q 20/36

(57) ABSTRACT

An apparatus includes a fraud detector, an account number generator, and an account provisioner. The fraud detector compares activity on an account to a fraud model and determines an indication of fraud on the account. In response to the determination that there is an indication of fraud on the account, the fraud detector communicates a fraud alert to an owner of the account. The fraud detector receives a response to the fraud alert and determines that fraudulent activity has occurred on the account. The account number generator, in response to the determination that fraudulent activity has occurred on the account, voids a card number of the account and generates a new card number for the account. The account provisioner communicates, in response to the generation of the new card number, the new number to a mobile wallet on a mobile device of the owner of the account.

### TECHNICAL FIELD

This disclosure relates generally to detecting and remedying fraud.

### BACKGROUND

When fraudulent activity is detected on an account, new credentials may need to be issued before an account holder may use the account again. Mobile wallets on mobile devices allow individuals to use one or more accounts through a mobile device.

### SUMMARY OF THE DISCLOSURE

According to an embodiment, an apparatus includes a fraud detector, an account number generator, and an account provisioner. The fraud detector compares activity on an account to a fraud model and determines that there is an indication of fraud on the account. In response to the determination that there is an indication of fraud on the account, the fraud detector communicates a fraud alert to an owner of the account. The fraud detector receives a response to the fraud alert and determines that fraudulent activity has occurred on the account. The account number generator, in response to the determination that fraudulent activity has occurred on the account, voids a card number of the account and generates a new card number for the account. The account provisioner communicates, in response to the generation of the new card number, the new number to a mobile wallet on a mobile device of the owner of the account.

According to another embodiment, a method includes comparing activity on an account to a fraud model and determining, based on the comparison of the activity to the fraud model, that there is an indication of fraud on the account. The method further includes, in response to determining that there is an indication of fraud on the account, communicating a fraud alert to an owner of the account. The method further includes receiving a response to the fraud alert and determining, based on the received response, that fraudulent activity has occurred on the account. The method further includes, in response to determining that fraudulent activity has occurred on the account, voiding a card number of the account and generating a new card number for the account. The method further includes communicating, in response to the generation of the new card number, the new number to a mobile wallet on a mobile device of the owner of the account.

According to yet another embodiment, a system includes a device configured to store a mobile wallet and a fraud remedy tool. The fraud remedy tool compares activity on the account to a fraud model and determines, based on the comparison of the activity to the fraud model, that there is an indication of fraud on an account. The fraud remedy tool, in response to the determination that there is an indication of fraud on the account, communicates a fraud alert to the device. The fraud remedy tool receives a response to the fraud alert and determines, based on the received response, that fraudulent activity has occurred on the account. In response to the determination that fraudulent activity has occurred on the account, fraud remedy tool voids a card number of the account and generates a new card number for the account. The fraud remedy tool communicates, in response to the generation of the new card number, the new number to the mobile wallet on the device.

Certain embodiments provide one or more technical advantages. For example, communicating the new card number to the mobile device reduces the processes necessary to allow the owner of the account to use the new card number with their mobile wallet. By reducing the number of steps and systems involved, certain embodiments reduce the required processing resources and potential failure points in the processing systems. As another example, an embodiment improves fraud remediation by removing the voided card number from the mobile wallet before communicating the new card number. Removing the voided card number reduces the risk of additional card declines and fraud indications. As yet another example, an embodiment improves security of the account by verifying the mobile device is controlled by the owner of the account before communicating the new card number. For instance, an account provisioner may make such a verification using a passcode or biometric information of the owner. Certain embodiments may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present disclosure, reference is now made to the following description, taken in conjunction with the accompanying drawings, in which:

FIG. 1 illustrates a system for remedying fraud;

FIG. 2 illustrates the fraud remedy tool of the system of FIG. 1; and

FIG. 3 is a flowchart illustrating a method for remedying fraud using the system of FIG. 1.

### DETAILED DESCRIPTION

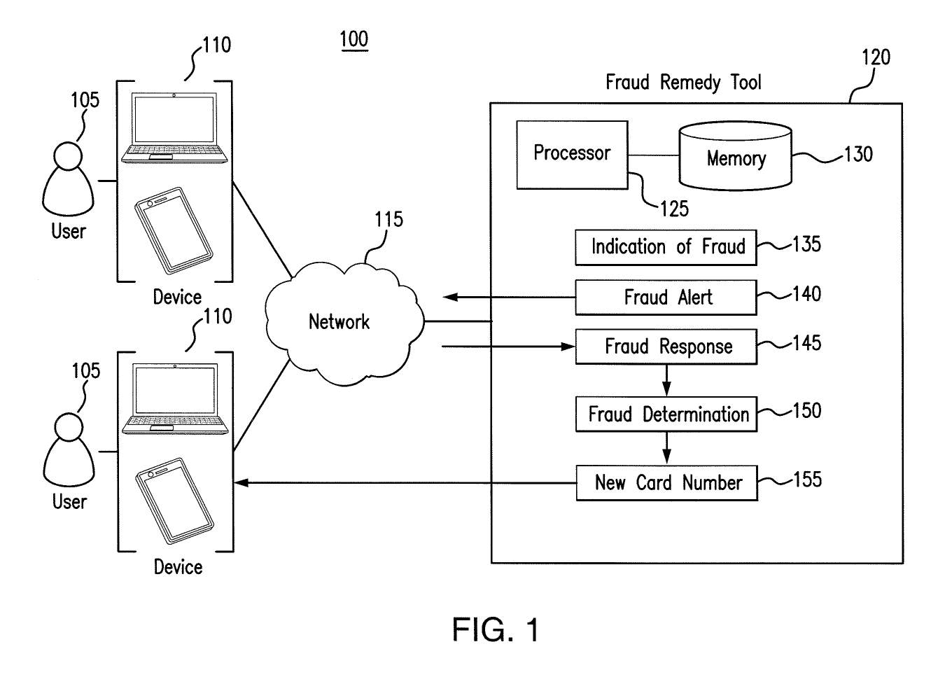

Embodiments of the present disclosure and its advantages are best understood by referring to FIGS. 1 through 3 of the drawings, like numerals being used for like and corresponding parts of the various drawings.

Generally, account holders may obtain physical credentials, which allow an account holder to authorize transactions on the account. For example, in the case of a credit account, the account holder may obtain a physical credit card that is presented alongside an identification card and signature at a point of sale to authorize a charge on the account. Physical credentials also allow an account holder to use their accounts with online merchants. In the example of a credit card, an account holder does not physically present the credit card, but instead inputs the credit card number alongside a security code unique to the physical credit card in order to authorize the transaction on the account. Thus, even in digital transactions, physical credentials may be required.

Alternatively, an account holder may authorize transactions on an account without physical credentials using a mobile wallet on one or more of their devices. For example, an account holder may provision an account to their mobile wallet on his cell phone using his physical credentials. After the account is provisioned, the account holder may not need to use their physical credentials to authorize a transaction on the account. Instead, the account holder may authorize a transaction by accessing his mobile wallet on his device.

A mobile wallet may store one or more numbers associated with the account holder's accounts. For example, the mobile wallet may hold a credit card number associated with a credit account. A mobile wallet may hold multiple numbers representing different accounts (e.g., debit accounts, membership accounts, gift cards, etc.). Thus, an account holder with several accounts would need only a single mobile wallet in order to authorize transactions on all of his accounts once provisioned to the mobile wallet. In this manner, physical credentials may allow an account holder to provision accounts onto a mobile wallet, which then, eliminates the need to carry or present the physical credentials.

Even with the increase in fraud detection and awareness of security issues, an account may be compromised through identity theft or other means. Moreover, with the increase of account transactions authorized over the internet, accounts may be compromised through unauthorized access to the institutions holding security information on those accounts. For example, servers storing credit card numbers and security codes for online purchases may be compromised. Once obtained, unauthorized individuals may attempt to use those credentials to authorize transactions on the account.

When fraudulent activity is detected, an institution overseeing the account may be informed of the fraud and take certain measures to protect the account from further fraudulent activity. In some cases, the institution may change the credentials for the account. For example, the institution may change a credit card number associated with the account to protect the account from further fraudulent activity, such as in the case of a stolen credit card.

Once the card number has been changed, the account holder may not use physical credentials with that card number to authorize transactions on the account. Because the mobile wallet relies on the physical credentials used to add the card number to the mobile wallet, the change of credentials also prevents the account holder from using the mobile wallet to authorize transactions on the account. Before resuming his use of the account, the account holder must receive additional physical credentials and add those physical credentials to the mobile wallet. For example, the institution may mail the account holder a new card and the account holder may need to wait for the new card to arrive through the mail before being able to authorize transactions on the account. Not only does this delay the use of the account until physical credentials are received, but also requires the institution in charge of the account to process the creation of the new physical credentials and the reprovisioning of the account to the mobile wallet using the new physical credentials. These additional steps require the use of additional systems and tools that increase the number of points of failure, reducing the effectiveness in remedying fraudulent activity.

For instance, the institution need not only void the old card number, create the new card number, and associate the card number with the account, but also go through the process of creating the physical credentials embodying the new card number, including additional security codes or other security information. The creation, storage, and processing of the additional security information uses additional tools and systems to verify the security information and to ensure its security from unauthorized access. Furthermore, the re-provisioning of the account with the new physical credentials on a an account holder's mobile wallet uses the support of additional systems and processing. Likewise, the accountholder may also take additional steps to add the new card number to their mobile wallet. The additional systems and processes provide additional fault points in which systems may fail or otherwise prevent or delay account holders from using their accounts. An institution with a sizable number of accounts may take such steps many times on a daily basis, requiring substantial processing and coordination across multiple systems and tools.

This disclosure contemplates an unconventional fraud remedy tool which communicates a new card number on an account to a mobile wallet in response to fraudulent activity. In this manner, the fraud remedy tool protects the account holder from further fraud while also enabling the use of the new card number through the mobile wallet without the additional steps of processing the new physical credentials and adding the new card number, which reduces the delay experienced by the account holder. For example, the fraud remedy tool may receive an indication of fraud, verify that fraudulent activity has occurred, and then create a new card number which is then communicated to the mobile wallet of the user on their mobile device. The fraud remedy tool may also void an old card number on the mobile wallet and replace it with a new card number. As a result, duplicate numbers will not be available on the mobile wallet and the old number may not be accidentally used creating new fraud indications. As yet another example, the fraud remedy tool may verify the account holder is in control of the device with the mobile wallet before adding the new card number.

There may be a number of other technical advantages. For example, communicating the new card number to the mobile device reduces the processes used to allow the owner of the account to use the new card number with their mobile wallet. By reducing the number of steps and systems involved, certain embodiments improve the functioning of the underlying computer technology by reducing the required processing resources and potential failure points. As another example, an embodiment improves fraud remediation by removing the voided card number from the mobile wallet before communicating the new card number. Removing the voided card number reduces the risk of additional card declines and fraud indications, which would require additional steps to resolve. As yet another example, an embodiment improves security of the account by verifying that the mobile device is controlled by the owner of the account before communicating the new card number. For instance, an account provisioner may make such a verification using a passcode or biometric information received from the account holder.

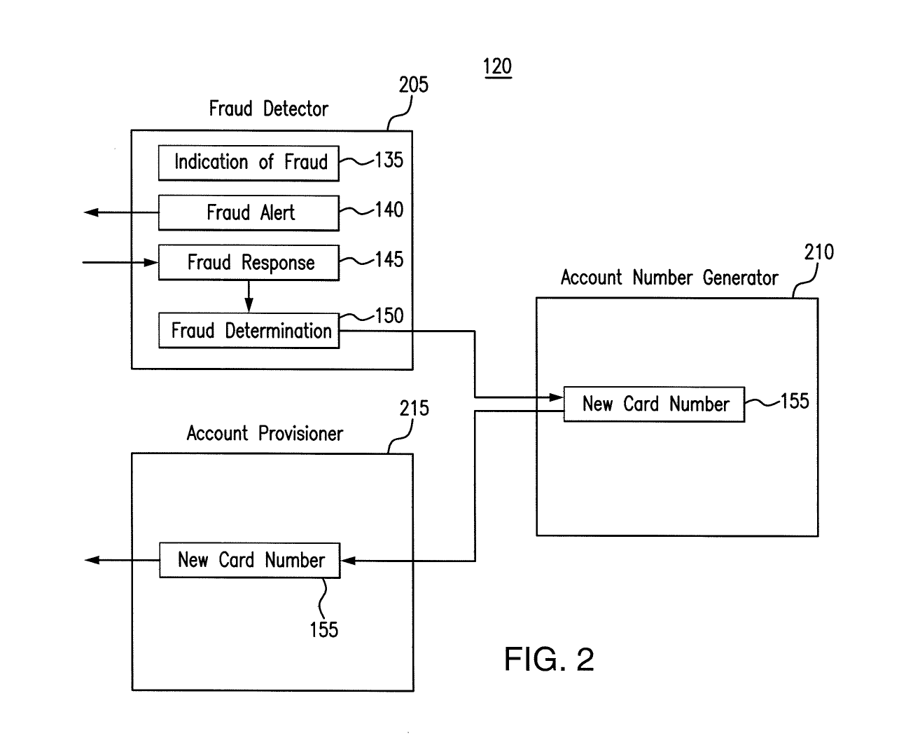

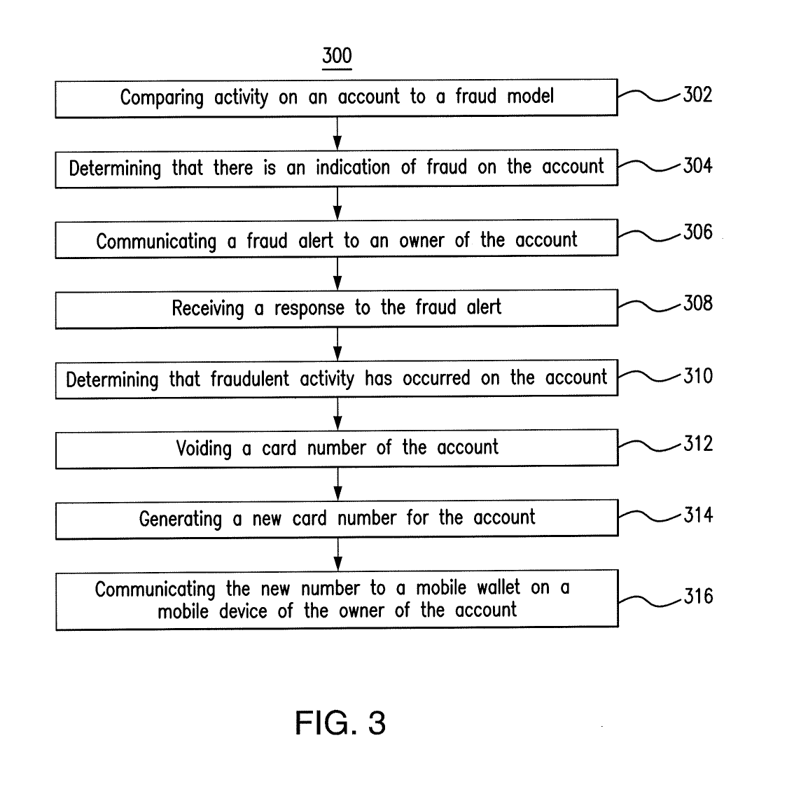

Additionally, the fraud remedy tool may remedy fraud without requiring the creation of new physical credentials. In particular embodiments, a temporary card number may be issued by the fraud remedy tool. In this manner, the accountholder may use the account using the temporary card number for a limited time even if a permanent card number has not yet been associated with the account. The fraud remedy tool may then remove the temporary card number after a predetermined amount of time in order to protect against further fraud on the account. The fraud remedy tool will be described in more detail using FIGS. 1 through 3. FIG. 1 will describe the fraud remedy tool generally. FIGS. 2 and 3 will describe the fraud remedy tool in more detail.

FIG. 1 illustrates a system for remedying fraud. As illustrated in FIG. 1, system 100 includes one or more devices 110, a network 115, and a fraud remedy tool 120. In particular embodiments, system 100 remedies fraud by communicating a new card number to a mobile wallet on device 110 in response to fraudulent activity.

Devices 110 may be any devices that operate and/or communicate with other components of system 100. Devices 110 may be any device configured to communicate with other components of system 100. For example, devices 110 may communicate with fraud remedy tool 120. This disclosure contemplates device 110 being any appropriate device for sending and receiving communications over network 115. As an example and not by way of limitation, device 110 may be a computer, a laptop, a wireless or cellular telephone, an electronic notebook, a personal digital assistant, a tablet, or any other device capable of receiving, processing, storing, and/or communicating information with other components of system 100. Device 110 may also include a user interface, such as a display, a microphone, keypad, or other appropriate terminal equipment usable by user 105. In some embodiments, an application executed by device 110 may perform the functions described herein.

Devices 110 may store a mobile wallet. A mobile wallet may be implemented as separate hardware and/or software within devices 110. The mobile wallet may allow a user 105 of device 110 to access accounts through device 110 without the use of any other physical credentials or verification. As an example, user 105 can store a credit card number associated with a credit card account on the mobile wallet on device 110. In such cases, user 105 may use the physical credit card in order to store the credit card number in the mobile wallet in device 110. User 105 may store other accounts, e.g. debit accounts, membership accounts, and gift cards, in a similar manner.

Before accessing the account through the mobile wallet, user 105 may first have the account provisioned to the mobile wallet on device 110. Different institutions overseeing accounts and different mobile wallet implementations may use a variety of methods to provision a new account to a particular mobile wallet. As an example, user 105 has a credit account with an institution and has received a credit card that allows user 105 to authorize transactions on the account. User 105 may use an application on device 110 to begin the provisioning process. For example, the mobile wallet on device 110 may have an application through which the mobile wallet may interact with device 110 and user 105. User 105 may transmit information from the credit card, such as the credit card number, expiration date, card holder's name, and a security code, to the mobile wallet on device 110. The mobile wallet may confirm the information as valid by communicating with the institution in charge of the account. After verifying the information, the account may be provisioned on the mobile wallet, and user 105 may use the stored card number to authorize transactions on the account using device 110.

In instances of fraud on a credit card account, the credit card number associated with that account is voided. However, this renders the credit card number stored in the mobile wallet of device 110 unusable. For example, using a voided card or voided card number may result in declined charges and/or additional fraud indications. Not until a new physical credit card is obtained with new security information, can user 105 authorize transactions on the account again. Furthermore, user 105 may have to reprovision the account using the new physical credit card in order to reauthorize the mobile wallet and update the card number. As discussed above, these additional processes may result in an immense amount of coordination and resources. User 105 is also burdened with having to go through the same steps to reprovision the account, even when fraudulent activity was through no fault of his own.

Network 115 facilitates communication between and amongst the various components of system 100. This disclosure contemplates network 115 being any suitable network operable to facilitate communication between the components of system 100. Network 115 may include any interconnecting system capable of transmitting audio, video, signals, data, messages, or any combination of the preceding. Network 115 may include all or a portion of a public switched telephone network (PSTN), a public or private data network, a local area network (LAN), a metropolitan area network (MAN), a wide area network (WAN), a local, regional, or global communication or computer network, such as the Internet, a wireline or wireless network, an enterprise intranet, or any other suitable communication link, including combinations thereof, operable to facilitate communication between the components.

Fraud remedy tool 120 communicates a new card number to a mobile wallet in response to fraudulent activity on the account. As illustrated in FIG. 1, fraud remedy tool 120 includes a processor 125 and a memory 130. This disclosure contemplates processor 125 and memory 130 being configured to perform any of the operations of fraud remedy tool 120 described herein. In particular embodiments, fraud remedy tool 120 improves the process of generating a new card number and communicating that number to the mobile wallet when fraud has been determined on an account.

Processor 125 is any electronic circuitry, including, but not limited to microprocessors, application specific integrated circuits (ASIC), application specific instruction set processor (ASIP), and/or state machines, that communicatively couples to memory 130 and controls the operation of fraud remedy tool 120. Processor 125 may be 8-bit, 16-bit, 32-bit, 64-bit or of any other suitable architecture. Processor 125 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components. Processor 125 may include other hardware and software that operates to control and process information. Processor 125 executes software stored on memory to perform any of the functions described herein. Processor 125 controls the operation and administration of fraud remedy tool 120 by processing information received from network 115, device(s) 110, and memory 130. Processor 125 may be a programmable logic device, a microcontroller, a microprocessor, any suitable processing device, or any suitable combination of the preceding. Processor 125 is not limited to a single processing device and may encompass multiple processing devices.

Memory 130 may store, either permanently or temporarily, data, operational software, or other information for processor 125. Memory 130 may include any one or a combination of volatile or non-volatile local or remote devices suitable for storing information. For example, memory 130 may include random access memory (RAM), read only memory (ROM), magnetic storage devices, optical storage devices, or any other suitable information storage device or a combination of these devices. The software represents any suitable set of instructions, logic, or code embodied in a computer-readable storage medium. For example, the software may be embodied in memory 130, a disk, a CD, or a flash drive. In particular embodiments, the software may include an application executable by processor 125 to perform one or more of the functions described herein.

Fraud remedy tool 120 determines an indication of fraud 135. Indication of fraud 135 may include information which indicates that fraudulent activity has occurred on an account. The information which indicates fraudulent activity may come from outside fraud remedy tool 120. For example, account activity information may be generated by a separate system or tool and sent to fraud remedy tool 120 through network 115 or by another communication method. Indication of fraud 135 may be generated by comparing activity on an account to a fraud model. In certain embodiments, fraud remedy tool 120 compares activity on the account to a fraud model. For example, the fraud model may compare past transactions to current transactions on the account in order to determine if fraudulent activity has occurred on the account. In particular examples, detailed information about past transactions may be used, such as the geographical location of the transactions, the types of transactions, the amounts in the transactions, the activity rate on the account, and other conventional indicators used in fraud models. Based on the comparison of the activity to the fraud model, the fraud remedy tool 120 determines indication of fraud 135. In particular embodiments, fraud remedy tool 120 receives an alert to check for fraudulent activity on an account. For example, a credit account owner who has lost his credit card may communicate to the credit card company that his card has been lost. Fraud remedy tool 120 may receive that information and check account activity and compare it to a fraud model to determine indication of fraud 135.

Fraud remedy tool 120, in response to the determined indication of fraud 135, may communicate a fraud alert 140 to device 110 of an account holder. Fraud remedy tool 120 may send fraud alert 140 to confirm that fraudulent activity has occurred on the account. While fraud models have become more sophisticated over time, they are not perfect and fraud remedy tool 120 may attempt to receive confirmation of fraud before taking further action. In particular embodiments, no such fraud alert 140 may be sent and instead, fraud remedy tool 120 may continue on to making a fraud determination 150, as discussed below. Fraud alert 140 may be sent via any communication device or method, including through network 115. For example, user 105 may receive a text message (e.g., an SMS message, MMS message, email, etc.) on device 110 indicating that fraudulent activity has been suspected and requesting user 105 to confirm fraudulent activity or allow the indicated fraudulent transaction to occur.

In the case that the owner of the account responds to the fraud alert 140 affirmatively, (e.g., that fraudulent activity has indeed occurred on the account), fraud remedy tool 120 may then receive fraud response 145 as a response to fraud alert 140. Similar to fraud alert 140, fraud response 145 may be sent and received through any communication device or method, including by device 110 through network 115. Fraud alert 140 and fraud response 145 may be received and sent by the same or different device 110. For example, user 105 may receive fraud alert 140 via text message and provide fraud response 145 through an email or phone call. Furthermore, fraud alert 140 may be received by user 105 by a separate device than is used by user 105 to send fraud response 145. The communication of fraud alert 140 and fraud response 145 may occur using device 110 on which the mobile wallet resides, or through a separate device not using a mobile wallet.

Fraud remedy tool 120, based on the receive response 145, then determines whether fraudulent activity has occurred on the account. If fraud remedy tool 120 determines that the suspicious activity was fraudulent, it may make a fraud determination 150. In response to fraud determination, fraud remedy tool 150 can take further steps in order to remedy the fraud.

Fraud remedy tool 120 generate new card number 155 for the account in response to the determination that fraudulent activity has occurred on the account. In this manner, fraud remedy tool 120 may remedy the fraud on the account by creating a new credential through which the account holder may authorize transactions on the account. For example, in the case of a credit card account, fraud remedy tool 120 may generate a new credit card number on the account. In particular embodiments, fraud remedy tool 120 may void the current card number on the account number in response to fraud determination 150 before generating a new card number on the account. In addition, in certain embodiments, fraud remedy tool 120 may generate a new card number which is not associated with any other account. In this manner, fraud remedy tool may avoid using a card number already associated with another account.

Fraud remedy tool 120 may then communicate new card number 155 to a mobile wallet stored on device 110 of the account holder. In particular, fraud remedy tool 120 may communicate with device 110 in order to push new card number 155 to the mobile wallet of user 105. In particular embodiments, fraud remedy tool 120 removes the voided card number from the mobile wallet before communicating new card number 155.

By adding new card number 155 to the mobile wallet, in certain embodiments, fraud remedy tool 120 allows the owner of the account to access the account and authorize transactions on the account using that added number on device 110. For example, user 105 may present device 110 storing the mobile wallet in order to authorize a transaction on the account using new card number 155 in the mobile wallet.

In certain embodiments, fraud remedy tool 120 provides an unconventional approach that improves the functioning of the underlying computer technology of a fraud detection and remediation system. For example, by issuing a new card number to a mobile wallet in response to detected fraudulent activity, fraud remedy tool 120 reduces the number of potential failure points and the required amount of processing resources associated with remedying fraud (e.g., generating new credentials for a physical card and creating the new physical card).

Modifications, additions, or omissions can be made to system 100 without departing from the scope of the invention. The components of system 100 can be integrated or separated. Moreover, the operations of system 100 can be performed by more, fewer, or other components.

FIG. 2 illustrates the fraud remedy tool 120 of system 100 of FIG. 1. As illustrated in FIG. 2, fraud remedy tool 120 includes fraud detector 205, account number generator 210, and account provisioner 215. In particular embodiments, fraud remedy tool 120 improves the process of fraudulent activity on an account by communicating a new card number to a mobile wallet on device 110 owned by the account holder.

Fraud detector 205 may compare activity on an account to a fraud model. The activity on the account may include transactions on the account and information associated with those transactions. For example, in the case of a credit card account, fraud detector 205 may receive credit card transactions, including information regarding the amounts of the transactions, the merchant for each transaction, and geographical location information associated with the transactions. Any suitable information relating to the activity on an account may be used by fraud detector 205 to compare it to a fraud model.

Fraud detector 205 may then determine, based on the comparison of the activity to the fraud model, suspicious activity on the account. For example, the comparison may show that the activity deviates from historical activity on the account, which may indicate fraudulent activity. In certain embodiments, fraud detector 205 determines indication of fraud 135 based on the comparison of the activity to the fraud model.

Fraud detector 205, in response to indication of fraud 135, communicates fraud alert 140 to the account holder. Fraud detector 205 may receive fraud response 145 in response to fraud alert 140. Fraud response 145 may be a confirmation that fraudulent activity has indeed occurred or it may indicate that no fraudulent activity has occurred. Fraud detector 205 may receive fraud response 145 directly from an owner on the account or another authorized user on the account or may receive fraud response 145 indirectly through another system or tool. Fraud response 145 may be further processed by other components of system 100 or additional systems in communication with system 100. In certain embodiments, no response to fraud alert 140 is received by fraud detector 205. In such cases, fraud detector 205 may continue to remedy the fraud according to predetermined settings. For example, if a response to fraud alert 140 is not received within 1 hour, fraud detector 205 may continue remedying the fraudulent activity on the assumption that fraudulent activity has occurred.

Account number generator 210 may receive fraud determination 150 from fraud detector 205. Account number generator 210, in response to the determination that fraudulent activity has occurred on the account, may void a card number of that account. For example, in the case of a credit card account, account number generator 210 may void a credit card number on the account so that the credit card number may no longer be used to authorize transactions or other activity on the account. Furthermore, account number generator 210, in response to the determination that fraudulent activity has occurred on the account, may generate a new card number 155 on the account. New card number 155 may replace the voided card number on the account. For example, an account holder may use new card number 155 as a new credential in order to authorize transactions on the account. Account number generator 210 may communicate a new card number to account provisioner 215.

Account provisioner 215 may receive new card number 155 from account number generator 210. In response to the generation of new card number 155, account provisioner 215 may communicate new card number 155 to a mobile wallet on device 110.

In particular embodiments, account provisioner 215 may first remove the voided card number from the mobile wallet before communicating new card number 155 to the mobile wallet. For example, after the card number is voided by account number generator 210, the mobile wallet may still comprise that card number. User 105 may not, however, use the voided card number even though it is still in the mobile wallet on device 110. If the voided card number is not removed, user 105 may accidently use the voided card number in his mobile wallet, which may result in declined charges and additional fraudulent activity determinations. By first removing the voided card number, account provisioner 215 may reduce wasted processing resources by system 100 and fraud remedy tool 120. In this manner, there is a seamless transition from the old card number to new card number 155 on the mobile wallet.

Account provisioner 215 may begin communicating new card number 155 to the mobile wallet by initiating a communication with mobile device 110. The initiation of the communication with mobile device 110 may require the transmission of other credentials by user 105. In certain embodiments, account provisioner 215 may verify that device 110 is actually being controlled by the account holder. If device 110 is in the possession of another, account provisioner 215 may not communicate new card number 155. In some instances, if new card number 155 is sent to the mobile wallet, the person possessing device 110 may use new card number 155 regardless if they are the account holder. For example, if the determined fraudulent activity occurred through a stolen cell phone's mobile wallet, communicating new card number 155 to the stolen cell phone may enable the thief to further commit fraud on the account using new card number 155.

In particular embodiments, account provisioner 215 may verify that device 110 is controlled by the account holder using credentials separate from the voided card number or corresponding physical credential. In certain embodiments, other physical credentials, such as biometric data of the account holder, may be used to verify that the device is still under the account holder's control. For example, a fingerprint of user 105 may be sent in response to the generation of new card number 155 to initiate its communication from account provisioner 215. As another example, user 105 may send a photograph of user 105 to verify device 110 is under his control.

In particular embodiments, the credentials sent by user 105 to initiate the communication of new card number 155 may include non-physical credentials. For example, account provisioner 215 may request a passcode known to user 105 before communicating new card number 155. As another example, two-factor authentication may be used to verify user 105 of device 110 is the account holder. As yet another example, security questions set by user 105 may be asked before communicating new card number 155. Any suitable security measures may be used to ensure that the person possessing device 110 is the account holder before communicating new card number 155 to the mobile wallet on device 110. Moreover, any of the exemplified credentials may be used alone or in combination with each other. For example, a fingerprint and a passcode may be required to verify that device 110 is controlled by the account holder

Account provisioning is the process of adding an account to a mobile wallet. Provisioning an account may require several steps on the behalf of the institution in charge of the account and the account holder. For example, user 105 may use a physical credential for the account in order to provision the account on a mobile wallet on device 110. In the example of a credit card as the physical credential, user 105 may take a photo of the physical credit card and enter a security code associated with the physical credit card in order to provision the account on the mobile wallet. The mobile wallet, through device 110, may communicate with the institution to verify the information entered by user 105. In some cases, the provisioning process involves multiple steps and multiple systems before the account is provisioned. A person having ordinary skill in the art would recognize that there are various ways to provision an account and any suitable method of provisioning an account may be used by account provisioner 215.

In particular embodiments, account provisioner 215 may first provision the account to the mobile wallet before communicating new card number 155 to the mobile wallet. In some instances, user 105 may not have provisioned their account on device 110 and its mobile wallet before fraudulent activity has occurred. For example, a user may have a credit card account and a physical credit card, but may not have previously provisioned the account on a mobile wallet on his device 110. When fraudulent activity occurs on that credit account, the physical credit card may be unusable because the card number has been voided by account number generator 210. As a result, user 105 may be unable to provision the account using the voided credit card number, which may be required before account provisioner 215 may communicate new card number 155. In such cases, account provisioner 215 may provision the account to the mobile wallet before sending new card number 155.

For example, if user 105 only has a physical credit card with a voided card number, user 105 may not use that physical credit card to provision the account on mobile wallet on device 110. Instead, user 105 may verify he is the account holder using other credentials associated with the account. After providing those other credentials, the institution may authorize the provisioning of the account to the mobile wallet. For example, fraud remedy tool 120 may receive the other credentials from user 105 in response to determined fraudulent activity. The credentials may be used by account provisioner 215 to verify that user 105 is indeed in control of device 110 and has authorized the account to be provisioned to the mobile wallet on device 110. Thus, account provisioner 215 may provision the account before communicating the new card 155. In this manner, fraud remedy tool 120 may reduce the resources required to remedy fraud when the account has not been previously provisioned to a mobile wallet. Additionally, user 105 need not wait to receive a physical credential with new card number 155 in order to provision the account on the mobile wallet.

As an example, fraud remedy system 120 may be used to remedy fraud when user 105 is at a point of sale at a merchant. User 105 may receive notification from the merchant at the point of sale that his credit card has been declined, e.g., in response to the card number being void because of detected fraudulent activity. If user 105 has a mobile wallet with the credit card account already provisioned, the fraud remedy tool 120 may communicate new card number 155, and user 105 may use the updated number in his mobile wallet to complete the transaction. If, however, user 105 does not have a mobile wallet with the account already provisioned, they may not be able to use the generated new card number 155 without receiving the physical credential, e.g., the new credit card. Typically, in this case, user 105 would have to use another account or would be unable to continue their purchase or transaction. In contrast, in certain embodiments, fraud remedy tool 120 may allow user 105 to first provision the account before receiving new card number 155. In this way, user 105 may use new card number 155 in a seamless manner at the point of sale.

In particular embodiments, new card number 155 is a temporary card number and account provisioner 215 may remove the temporary card number 155 from the mobile wallet on device 110 after a predetermined period of time. For example, in the case of a credit card account, new card number 155 may not be associated with a physical credit card of the account. In some cases, new card number 155 may be communicated to mobile wallet 110 for a limited time until user 105 has received the physical credential. In such cases, user 105 may later receive the physical credential and reprovision the account to add a card number associated with the physical credential number onto the mobile wallet of device 110. If user 105 does not take this step before a predetermined time, e.g., ten days, then new card number 155 may expire and account provisioner 215 may remove new card number 155 from mobile wallet, preventing its further use. In this manner, fraud remedy tool 120 may remove new card number 155 from the mobile wallet after the predetermined period of time.

In particular embodiments, account number generator 210 may allow the account holder to use the voided card number for transactions even after it has been voided. For example, user 105 may have authorized certain transactions before fraudulent activity was determined or the fraudulent activity occurred. In such cases, user 105 may want to prevent the cancellation of those transactions. Instead of having to reauthorize those transactions using new card number 155 or another account, account number generator 210 may allow the non-fraudulent transactions to remain authorized on the account, even though they were authorized using a voided card number. In addition, account number generator 210 may allow the account holder to use the voided card number for recurring transactions on the account for a predetermined period of time. For example, an electric bill paid automatically from the account every month may be paid out of the account for a certain period of time even if the automatic payments were authorized using the voided card number. The predetermined period of time may be determined by the type of account, the type of transaction, or other criteria. In this manner, fraud remedy tool 120 may allow the owner of the account to use the void number for particular transactions.

In certain embodiments, the various components of fraud remedy tool 120 provide an unconventional approach that improves the functioning of the underlying computer technology of a fraud detection and remediation system. For example, by issuing a new card number to a mobile wallet in response to detected fraudulent activity, fraud remedy tool 120 reduces the number of potential failure points and the required amount of processing resources associated with remedying fraud (e.g., generating new credentials for a physical card and creating the new physical card).

Modifications, additions, or omissions can be made to fraud remedy tool 120 without departing from the scope of the invention. The components of fraud remedy tool 120 can be integrated or separated. Moreover, the operations of fraud remedy tool 120 can be performed by more, fewer, or other components.

FIG. 3 is a flowchart illustrating a method 300 for remedying fraud using system 100 of FIG. 1. In particular embodiments, fraud remedy tool 120 performs method 300. By performing method 300, fraud remedy tool 120 communicates a new card number to a mobile wallet in response to detected fraud.

Fraud remedy tool 120 begins by comparing activity on an account to a fraud model in step 302. In step 304, fraud remedy tool 120 determines indication of fraud 135 on the account. The determining in step 304 may be based on the comparison of the activity on the account to the fraud model.

In step 306, fraud remedy tool 120 then communicates fraud alert 140 to an account holder of the account after determining indication of fraud 135 on the account. In this manner, account holder may confirm fraudulent activity on the account and may take additional steps to prevent further fraudulent activity.

In step 308, fraud remedy tool 120 receives a response to fraud alert 140 from the account holder. For example, fraud response 145 may confirm that fraudulent activity has occurred on the account. Fraud remedy tool 120 then determines that fraudulent activity has occurred on the account in step 310.

In response to determining that fraudulent activity has occurred on the account, fraud remedy tool 120 may then void a card number of the account in step 312. Also in response to determining that fraudulent activity has occurred, fraud remedy tool 120 may generate a new card number for the account in step 314.

Fraud remedy tool 120 may then communicate new card number 155 to a mobile wallet on device 110 of the account holder in step 316. In this manner, fraud remedy tool 120 may remedy fraudulent activity on the account by allowing the account holder to authorize transactions on the account using new card number 155 with their mobile wallet on his device 110.

In particular embodiments, method 300 may comprise additional steps. For example, in certain embodiments, method 300 further includes removing the voided card number from the mobile wallet before communicating the new card number to the mobile wallet. In certain embodiments, method 300 may further include provisioning the account to the mobile wallet before communicating the new card number to the mobile wallet. In certain embodiments, method 300 may further include removing new card number 155 from the mobile wallet after a predetermined period of time, wherein new card number 155 is a temporary card number.

Modifications, additions or omissions may be made to method 300 depicted in FIG. 3. Method 300 may include more, fewer, or other steps. For example, steps may be performed in parallel or any suitable order. While discussed as fraud remedy tool 120 performing the steps, any suitable component of system 100, such as devices 110 for example, may perform one or more of the steps of the method.

Although the present disclosure includes several embodiments, a myriad of changes, variations, alterations, transformations and modifications may be suggested to one skilled in the art and it is intended that the present disclosure encompass such changes, variations, alterations, transformations and modifications as fall within the scope of the appended claims.

What is claimed is:

1. An apparatus comprising:
a fraud detector configured to:
compare activity on an account to a fraud model;
determine, based on the comparison of the activity to the fraud model, that there is an indication of fraud on the account;
in response to the determination that there is an indication of fraud on the account, communicate a fraud alert to an owner of the account;
receive a response to the fraud alert; and
determine, based on the received response, that fraudulent activity has occurred on the account;
an account number generator configured to:
in response to the determination that fraudulent activity has occurred on the account, void a card number of the account; and
in response to the determination that fraudulent activity has occurred on the account, generate a new card number for the account; and
an account provisioner configured to communicate, in response to the generation of the new card number, the new number to a mobile wallet on a mobile device of the owner of the account.

2. The apparatus of claim 1, wherein the account provisioner is further configured to remove the card number from the mobile wallet before communicating the new card number to the mobile wallet.

3. The apparatus of claim 1, wherein the account provisioner is further configured to verify, based on a passcode, that the mobile device is controlled by the owner of the account before communicating the new card number

4. The apparatus of claim 1, wherein the account provisioner is further configured to verify, based on biometric information, that the mobile device is controlled by the owner of the account before communicating the new card number.

5. The apparatus of claim 1, wherein the account provisioner is further configured to provision the account to the mobile wallet before communicating the new card number to the mobile wallet.

6. The apparatus of claim 1, wherein communicating the new number to the mobile wallet allows the owner of the account to access the account and authorize transactions on the account using the new number on the mobile device.

7. The apparatus of claim 1, wherein:
the new card number is a temporary card number; and
the account provisioner is further configured to remove the new card number from the mobile wallet after a predetermined period of time.

8. The apparatus of claim 1, wherein the account number generator is further configured to allow the owner of the account to use the voided card number for transactions authorized before fraudulent activity was determined by the fraud detector and for recurring transactions for a predetermined period of time.

9. A method, comprising:
comparing activity on an account to a fraud model;
determining, based on the comparison of the activity to the fraud model, that there is an indication of fraud on the account;
in response to determining that there is an indication of fraud on the account, communicating a fraud alert to an owner of the account;
receiving a response to the fraud alert;
determining, based on the received response, that fraudulent activity has occurred on the account;
in response to determining that fraudulent activity has occurred on the account, voiding a card number of the account;
in response to determining that fraudulent activity has occurred on the account, generating a new card number for the account; and
communicating, in response to the generation of the new card number, the new number to a mobile wallet on a mobile device of the owner of the account.

10. The method of claim 9, further comprising removing the card number from the mobile wallet before communicating the new card number to the mobile wallet.

11. The method of claim 9, further comprising verifying, based on a passcode or biometric information, that the mobile device is controlled by the owner of the account before communicating the new card number.

12. The method of claim 9, further comprising provisioning the account to the mobile wallet before communicating the new card number to the mobile wallet.

13. The method of claim 9, wherein communicating the new number to the mobile wallet allows the owner of the account to access the account and authorize transactions on the account using the new number on the mobile device.

14. The method of claim 9, further comprising removing the new card number from the mobile wallet after a predetermined period of time, wherein the new card number is a temporary card number.

15. The method of claim 9, further comprising allowing the owner of the account to use the voided card number for transactions authorized before fraudulent activity was determined and for recurring transactions for a predetermined period of time.

16. A system comprising:
a device configured to store a mobile wallet; and
a fraud remedy tool configured to:
compare activity on the account to a fraud model;
determine, based on the comparison of the activity to the fraud model, that there is an indication of fraud on an account;
in response to the determination that there is an indication of fraud on the account, communicate a fraud alert to the device;
receive a response to the fraud alert;
determine, based on the received response, that fraudulent activity has occurred on the account;
in response to the determination that fraudulent activity has occurred on the account, void a card number of the account;
in response to the determination that fraudulent activity has occurred on the account, generate a new card number for the account; and
communicate, in response to the generation of the new card number, the new number to the mobile wallet on the device.

17. The system of claim 16, wherein the fraud remedy tool is further configured to remove the card number from the mobile wallet before communicating the new card number to the mobile wallet.

18. The system of claim 16, wherein the fraud remedy tool is further configured to verify, based on a passcode or biometric information, that the mobile device is controlled by an owner of the account before communicating the new card number.

19. The system of claim 16, wherein the fraud remedy tool is further configured to provision the account to the mobile wallet before communicating the new card number to the mobile wallet.

20. The system of claim 16, wherein adding the new number to the mobile wallet allows an owner of the account to access the account and authorize transactions on the account using the new number on the mobile device.

21. The system of claim 16, wherein:
the fraud remedy tool is further configured to remove the new card number from the mobile wallet after a predetermined period of time; and
the new card number is a temporary card number.

22. The system of claim 16, wherein the fraud remedy tool is further configured to allow an owner of the account to use the voided card number for transactions authorized before fraudulent activity was determined and for recurring transactions for a predetermined period of time.
